(19) United States
(12) Patent Application Publication
(10) Pub. No.: US 2016/0072650 A1
(43) Pub. Date: Mar. 10, 2016

(54) ADAPTIVE TERMINATION TUNING WITH BIASED PHASE DETECTOR IN A SERDES RECEIVER

(71) Applicant: LSI Corporation, San Jose, CA (US)

(72) Inventors: Mohammad S. Mobin, Orefield, PA (US); Sunil Srinivasa, San Jose, CA (US); Vladimir Sindalovsky, Warrington, PA (US); Amaresh V. Malipatil, San Jose, CA (US); Pervez M. Aziz, Dallas, TX (US)

(21) Appl. No.: 14/479,278

(22) Filed: Sep. 6, 2014

(51) Int. Cl. H04L 25/06; H04L 7/00

(52) U.S. Cl. CPC H04L 25/06; H04L 7/0087

(57) ABSTRACT

Described embodiments provide for, in a SerDes device, an adaptation process that adjusts termination impedance automatically to obtain a tuned termination. The termination adaptation is realized with a ‘biased’ bang-bang phase detector (BBPD) that biases the weights applied to UP and DOWN outputs of the phase detector. Through an optimization process, the system locks to data eye corners, and thereby is able to optimize termination though a predetermined criteria, such as signal to noise ratio (SNR), horizontal eye (H-) margin, vertical eye (V-) margin or joint SNR and H-/V-margin optimization. As part of the receiver equalization, adaptive termination tuning is performed after the SerDes receiver (RX) path is initially powered-up by tuning the termination above and below its current initial setting and performing the optimization process.

### BACKGROUND

In many data communication applications, Serializer and De-serializer (SerDes) devices facilitate the transmission between two points of parallel data across a serial link. Data at one point is converted from parallel data to serial data and transmitted through a communications channel to the second point where it received and converted from serial data to parallel data.

At high data rates, frequency-dependent signal loss from the communications channel (e.g., the signal path between the two end points of a serial link) as well as signal dispersion and distortion can occur. As such, the communications channel, whether wired, optical, or wireless, acts as a filter and might be modeled in the frequency domain with a transfer function. Correction for frequency dependent losses of the communications channel, and other forms of signal degradation, often requires signal equalization at a receiver of the signal. Equalization through use of one or more equalizers compensates for the signal degradation to improve communication quality.

In many data communication applications generating one or more different source clock signals, a clock and data recovery circuit (CDR) is employed to recover an input data clock signal, and generate clock signals having a known phase alignment. For example, SerDes devices that facilitate the transmission between two points of parallel data across a serial link often must generate multiple clock signals to support various standards. Bang-bang Phase Detectors (BBPDs) are employed in applications that require detection and phase alignment of these different clock domain sources.

An eye pattern, also known as an eye diagram (“data “eye” or “eye”), represents a digital data signal from a receiver that is repetitively sampled and applied to the vertical input (axis), while the horizontal input (axis) represents time as a function of the data rate. The eye diagram allows for evaluation of the combined effects of channel noise and inter-symbol interference on the performance of a baseband pulse-transmission system, and the input data eye is the synchronized superposition of all possible realizations of the signal of interest viewed within a particular signaling interval (referred to generally as the data eye), which for convenience might be referred to generally as a unit interval or “UI”. A data slicer (i.e., a Data Latch) in a SerDes device is used for digitizing an analog signal in the serial data receiver, and is usually set in magnitude and phase to the center of the data eye. Precision of the latch threshold has substantial impact on performance (e.g., error rate, jitter tolerance) of the SerDes device.

Current SerDes devices have a fixed termination impedance that may not necessarily be the best termination, even if it is trimmed to 50 ohm (the standard desired termination value) since the characteristic impedance of the channel may not necessarily be 50 ohm. In the current SerDes devices, the termination values in the transmit (TX) and receive (RX) paths are static and are prone to process, voltage and temperature (PVT) variation. A RX termination not matching the channel creates discontinuity at integrated circuit (IC) chip boundaries. Even an ideal 50 ohm termination is not necessarily the optimal termination. A mistuned termination with respect to the channel creates poor return loss and hence degraded receiver operating margin.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, an impedance in a receiver device is tuned by initializing current termination settings of front end-circuitry impedance to an initial termination set for a predefined input impedance value. A recursive sweep is performed over termination settings to generate a set of recorded margins, the performing a recursive sweep including at each iteration: i) generating a data eye from an input signal to a decision device, the input signal including a sequence of data symbols; ii) allowing phase detection, by a biased phase detector, of edges in the data eye; iii) generating a margin corresponding to the current termination settings of the settled phase based on a predefined criteria; iv) recording the margin corresponding to the current termination settings of the settled phase; and v) updating the current termination settings. When the recursive sweep is complete, a channel impedance-matched set of termination settings from the set of recorded margins is determined; and the current termination settings of front end-circuitry impedance are adjusted to the channel impedance-matched set.

### BRIEF DESCRIPTION OF THE DRAWINGS

Other aspects, features, and advantages will become more fully apparent from the following detailed description, the appended claims, and the accompanying drawings in which like reference numerals identify similar or identical elements.

FIG. 1 shows a block diagram of a Serializer-Deserializer (SerDes) receiver employing one or more exemplary embodiments;

FIG. 2 illustrates a biased bang-bang phase detector configured to lock to inner data eye corner(s);

FIG. 3 shows an eye diagram of an input signal and the associated latches as might be employed with the biased bang-bang phase detector of FIG. 2; and

FIG. 4 illustrates a process as might be employed by a state machine implementing an exemplary termination adaptation algorithm.

### DETAILED DESCRIPTION

In accordance with the described embodiments, an adaptation process adjusts termination impedance automatically to obtain a tuned termination. The termination adaptation is realized with a ‘biased’ bang-bang phase detector (BBPD) that biases the weights applied to UP and DOWN outputs of the phase detector. Through an optimization process, the system locks to data eye corners, described herein as locking to the left and right inner eye corners, and thereby is able to optimize termination though a predetermined criteria, such as signal to noise ratio (SNR); horizontal eye (H)-margin; vertical eye (V)-margin; or joint SNR, V-margin and H-margin optimization. As part of the receiver equalization, adaptive termination tuning is performed after the SerDes receiver (RX) path is initially powered-up by tuning the termination above and below its current initial setting and performing the optimization process over a termination sweep. Such RX path termination tuning can also be extended to the transmit (TX) path termination by incorporating termination tuning support as part of a back channel equalization protocol supporting termination information exchange in training ordered set field. An adaptation algorithm that adjusts the termination impedance maximizes horizontal eye opening, thereby improving the robustness of the receiver.

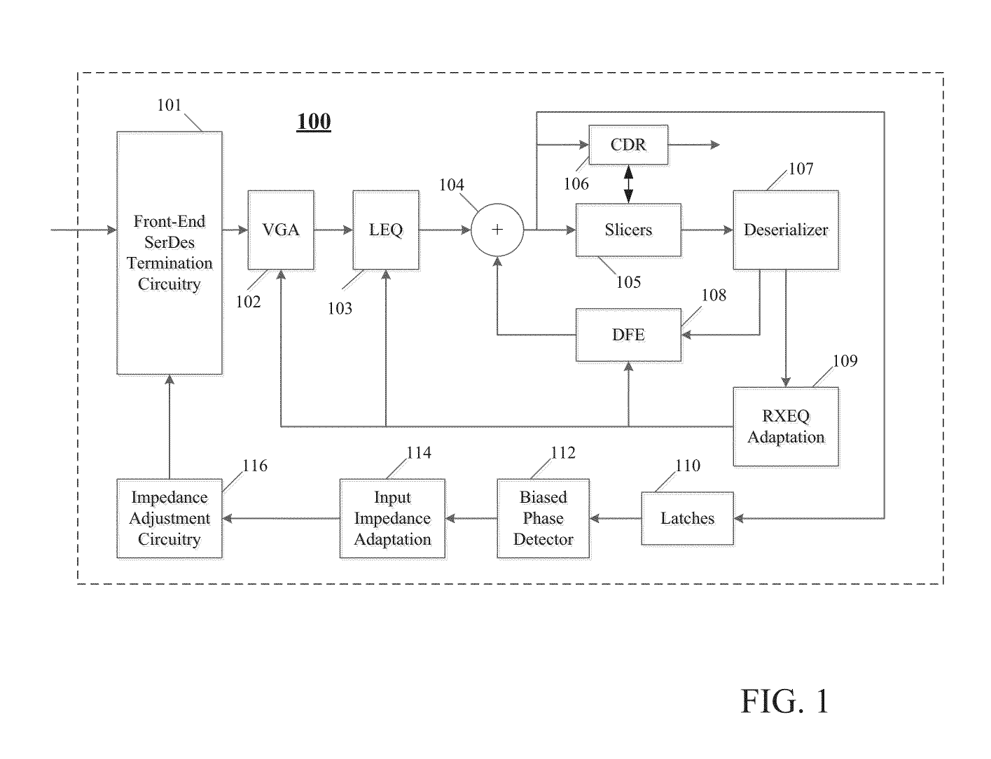

FIG. 1 shows an exemplary serializer-deserializer (SerDes) receiver 100 employing an exemplary embodiment. SerDes receiver 100 includes front-end SerDes termination circuitry 101 used to provide input termination impedance to outside devices coupled to the input of SerDes device 100. Front-end SerDes termination circuitry 101 might include circuit elements such as resistors, capacitors, inductances, transistors, amplifiers and the like employed to provide a termination impedance. Such circuit elements might have their element values changed via current and/or voltage biasing (via impedance adjustment circuitry 116), thereby adjusting their impedance values.

SerDes receiver 100 includes input amplifier (e.g., variable gain amplifier or VGA) 102, linear equalizer (e.g., analog linear equalizer or LEQ) 103, combiner 104, and slicers (e.g., latches) 105. Slicers 105 comprises one or more decision devices providing decisions for input data, and generates a reconstructed serial data stream. Clock and data recovery (CDR) 106 is coupled to slicers 105, and also receives the input to slicers 105. CDR 106 recovers an input data clock signal, and generates clock signals having a known phase alignment. CDR 106 comprises a phase detector (e.g., a BBPD) and associated logic controller to detect a center of a data eye and adjust transition and data sampling clocks. Output clock signals from CDR 106 might be employed to time sampling of latches placed within a data eye output from combiner 104. SerDes receiver 100 further includes deserializer 107, decision feedback equalizer (DFE) 108, and receiver equalizer coefficient adaptation circuitry (RXEQ adaptation) 109.

The serial input data from a channel, degraded after transmission through the channel, passes through front-end SerDes termination circuitry 101 to VGA 102 that provides amplification for gain enhancement, and then is further enhanced in LEQ 103 to compensate for potential low pass filtering characteristics of the channel. From LEQ 103, the data is sent to a summing node for additional enhancement using output from DFE 108. Slicers 105 provides decisions for input data, and generates the reconstructed serial data stream. Deserializer 107 deserializes the data for output, as well as for input decisions for DFE 108, which decision feedback equalization techniques are well known to those skilled in the art. All of the enhancement parameters are adapted through filter and coefficient adaptation processes of REXQ adaptation 109 in order to achieve maximum horizontal and vertical eye opening seen at (input to) slicers 105, which leads to a low error rate. Hence the accuracy of the latches of slicers 105 (data, transition and error for LMS adaptation algorithm) is important for achieving low SerDes error rates.

Slicers 105 represent one or more decision devices for a input data. As known in the art, the term “slicer” and “latch” are often used interchangeably for a decision device, which compares an input value to a threshold to generate an output decision based on a clock signal, and this clock signal (from a CDR) might be a sampling signal. Sampling is employed to detect transitions within the data eye as well as horizontal and vertical bounds, errors, and margins. The threshold of the latch determines a vertical height within the eye, while the phase determines the horizontal position of the threshold detection time within the eye.

SerDes receiver 100 incorporates an impedance adaptation controller including latches 110, biased phase detector 112, input impedance adaptation logic 114, and impedance adjustment circuitry 116. Termination adaptation in accordance with described embodiments employs latches 110 to detect horizontal levels in the data eye, as described subsequently, which are provided to biased phase detector 112, which locks to, for example, the left or right inner data eye point. The data eye point is provided to input impedance adaptation logic 114, which applies an optimization algorithm to adaptively adjust values of front-end SerDes termination circuitry 101 though control by impedance adjustment circuitry 116.

The termination adaptation is realized with a ‘biased’ bang-bang phase detector (BBPD) 112 that biases the weights applied to UP and DOWN outputs of the BBPD phase detector, rather than treating them equally. By weighting the BBPD UP and DOWN outputs differently, the system locks to the inner eye corner at a given BER, or other criteria such as horizontal data eye (H-)margin, vertical data eye (V-)margin, or both, and thereby termination adaptation is able to locate a relatively optimum input impedance for generating the inner eye for the criteria through application of a recursive algorithm.

In accordance with a first embodiment, a biased algorithm applied to the bang-bang detector measures inner eye width at a particular BER, allowing for calculation of H-Margin. H-Margin calculation using a biased algorithm is now described.

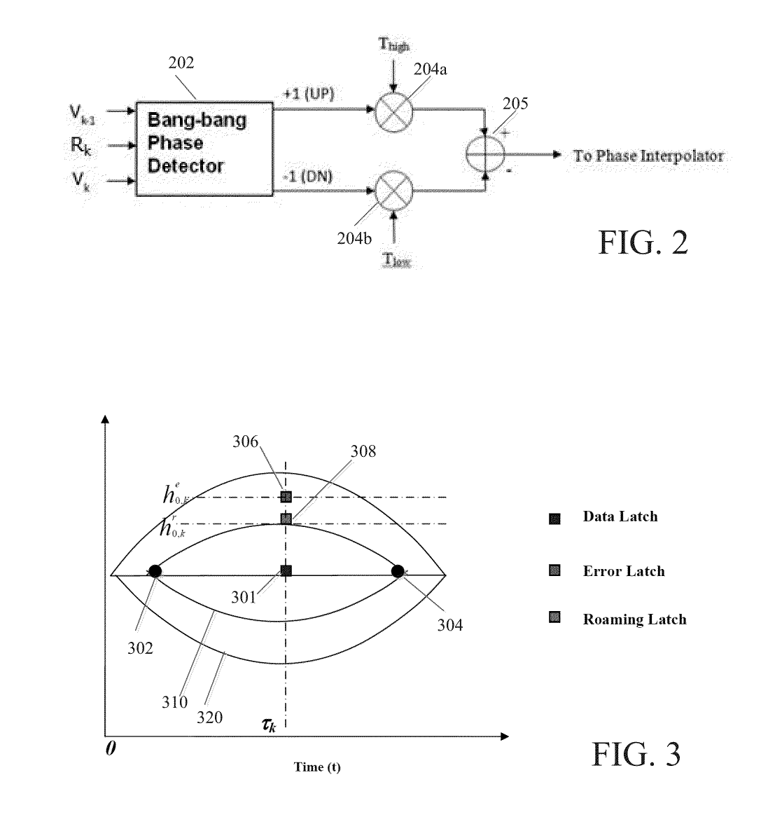

FIG. 2 illustrates a biased bang-bang phase detector (BBPD) 200 configured to lock to inner data eye corner(s). Biased BBPD comprises a BBPD 202, multipliers 204a and 204b, and combiner (e.g., adder) 205, which receives input from latches 110, where Rₖ is a value for a roaming latch positioned at the corner of the data eye, and vₖ and vₖ₋₁ are the k^{th} symbol and (k−1)^{th} symbol decisions, respectively. Based on the phase comparison, BBPD 202 either indicates a phase UP (+1) or phase DOWN (−1) increment. Multipliers 204a and 204b, receive weights T_{high} and T_{low}, T_{high}>T_{low} (when T_{high}=T_{low}, the circuit reduces to the conventional BBPD. As shown, the implementation of the biased phase detector that locks on to the left inner eye corner. A similar implementation (with simply T_{high} and T_{low} interchanged) may be used to let the phase detector settle to the right inner eye corner. The weighted (i.e., biased) BBPD outputs are combined in combiner 205 to provide a signal to the phase interpolator.

Adaptation algorithms, such as least-mean squared (LMS) and recursive-least squared (RLS), are used to determine optimal settings for equalization and clock and data recovery circuits in all practical communication receivers such as in SerDes (serializer-deserializer) devices. Sign-Sign algorithm is the most common algorithm used in practice. The update equation of a sign-sign adaptive algorithm can be generalized as given in relation (1):

Estimate(k+1)=Estimate(k)+μ*sign[Gradient(k)], (1)

where μ is the adaptation step size. The gradient and step size differentiate one algorithm from another, and are specified for a given implementation. The step size is fixed and independent of the sign of the gradient, in which case the algorithm is unbiased in terms of its step size.

In accordance with described embodiments, the algorithm is biased, to one direction or another as follows in (2A) and (2B):

Estimate(k+1)=Estimate(k)+μ⁺ if sign[Gradient(k)]=+1 (2A)

Estimate(k+1)=Estimate(k)+μ⁻ if sign[Gradient(k)]=−1 (2B)

where μ⁺ and μ⁻ are the step size for the positive and negative gradients, respectively. If μ⁺>μ⁻, the algorithm is biased in the positive direction. Conversely, if μ⁺<μ⁻, the algorithm is biased in the negative direction. When μ⁺ equals μ⁻, the algorithm reduces to the conventional relation of (1) above.

In order to realize H-margining adaptation in a SerDes device, the UP and DOWN values of the phase detector are weighted differently, such as with two weights T_{high} and T_{low}, As described with respect to FIG. 2. Knowledge of the left and right inner eye corners allows for proper eye centering (and hence maximum horizontal margin). As shown and described in FIG. 3, described subsequently, a biased phase detector locks onto either a left or a right inner eye corner. In order to settle to the inner eyes at a given BER of ρ, the thresholds should be selected such that T_{high}/T_{low}=(1−ρ)/ρ. Some embodiments might employ a table of values for T_{low} and T_{high} corresponding to different BERs. Using a biased BBPD, the left edge and the right edge of the inner data eye is detected with a suitable T_{high/low} threshold. The H-margin=T_{right}−T_{left} is calculated from these detected edges.

FIG. 3 shows an eye diagram of an input signal and the associated latches as might be employed with the biased bang-bang phase detector of FIG. 2. The eye diagram of the input signal illustrates many data symbols/transitions that are superimposed, and so includes contours representing inner eye 310 and outer eye 320. As shown, a data latch 301 is timed and threshold programmed so as to sit near the center of the inner eye 310, and this point is used as the data sampling point phase. When the biased BBPD of FIG. is employed, the phase settles near the left inner eye edge 302 and right inner eye edge 304. The distance between the left inner eye edge 302 and right inner eye edge 304 is the H-margin. Similarly, a measure of how “open” the eye is might be termed the vertical (i.e., V-) margin, which is the height of the eye above the center (data sampling point). Data latch 301, error latch 306 and roaming latch 308 are all aligned in phase τₖ at the sampling point.

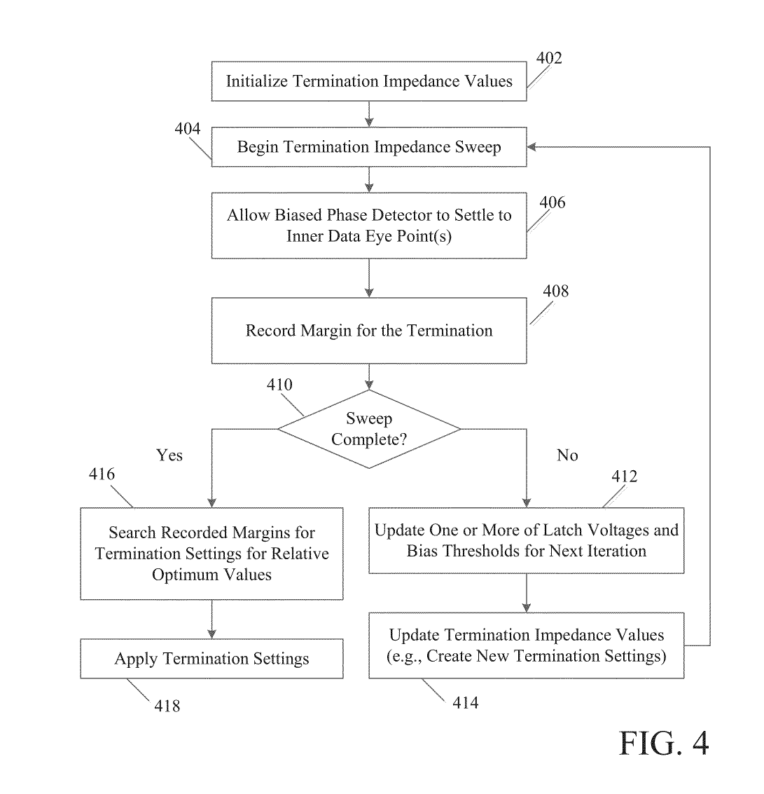

FIG. 4 illustrates a process as might be employed by a state machine or processor (e.g., processor circuitry and associated software) implementing an exemplary termination adaptation algorithm.

At step 402, as the SerDes system is brought up, initial termination settings are used for current termination settings of the termination impedance (e.g., of Front-end SerDes Termination Circuitry 101). At step 404, A termination impedance sweep begins. The termination sweep is an interative/recursive process that adjusts the termination settings over a range and selects optimum termination impedance values in accordance with an adaptation algorithm. At step 406, the biased phase detector is allowed to settle at inner eye points (e.g., left and right inner eye edges). At step 408, one or more margins are recorded for the current termination settings.

At step 410, a test determines whether the sweep is complete. The test of step 410, and subsequent steps, might be performed by a processor or logic circuitry such as shown in FIG. 1 (e.g., impedance adaptation logic 114, which applies an optimization algorithm to adaptively adjust values of Front-end SerDes Termination Circuitry 101 though control by impedance adjustment circuitry 116). If the test of step 410 determines the sweep is not complete (NO), then, at step 412, optionally one or more of the data, error and roaming latch voltages and bias thresholds might be updated for the next sweep iteration. At step 414, updated termination impedance values are generated as new termination settings, and the process returns to step 406.

If the test of step 410 determines the sweep is complete (YES), then, at step 416, the recorded margins are searched for the relative optimum values for the termination settings. At step 418, the relative optimum termination settings are applied to the front end circuitry to set the termination impedance. Although the process might end with step 418, other embodiments might continually monitor impedance, and repeat the process shown in FIG. 4 over time, especially as termination impedance changes with changing process, voltage and temperature.

Several embodiments within the spirit of the description of FIGS. 1-4 are now described.

In one embodiment, termination trimming is performed with a biased BBPD for H-margin Optimization. The termination resistance is set to a pre-defined set of values, a sweep is performed over the termination settings and for each setting the updated H-margin is recorded. At the end of the termination sweep, the termination setting that offered the relative best H-margin is programmed achieving an optimized system that matches receiver input characteristics impedance with the actual channel characteristics impedance of the channel.

In another embodiment, adaptive termination tuning using H-margin optimization with a biased BBPD and V-margin calculation is as follows. Referring to FIG. 3, the eye diagram of a NRZ (BPSK) signal illustrates placement of the associated latches in a SerDes receiver to measure (V)-margin. The data latch, error latch and the roaming latch are all aligned in phase at the sampling point. The error latch is used to obtain the error signal in (3):

(eₖ^{e}=yₖ−h_{0,k}^{e}vₖ) (3)

where, yₖ is the slicer input signal and vₖ is the k^{th} symbol decision) that drives the adaptation of various equalization and/or timing recovery loops in the receiver, and h_{0,k}^{e} represents the mean amplitude of yₖ and is adapted using the following update equation (4):

h_{0,k}^{e}=h_{0,k-1}^{e}+μeₖ^{e}vₖ (4)

where, when the relation (4) converges through adaptation, the relation (5) holds:

$$\frac{Number of samples < {h}_{0 , k}^{e}}{Number of samples > {h}_{0 , k}^{e}} = 1. \qquad ( 5 )$$

In order to determine the inner eye height using the roaming latch at any particular BER (ρ), at the convergence point, processing by the system attempts to satisfy relation (6):

$$\frac{Number of samples < {h}_{0 , k}^{r}}{Number of samples > {h}_{0 , k}^{r}} = ρ . \qquad ( 6 )$$

by employing the relations (7A) and (7B) to adapt the voltage offset of the roaming latch:

h_{0,k}^{r}=h_{0,k-1}^{r}+ρ if eₖ^{r}vₖ=1 (7A)

h_{0,k}^{r}=h_{0,k-1}^{r}−(1+ρ) if eₖ^{r}vₖ=−1 (7B)

Since the target BER (ρ) is typically very low, on the order of <10⁻¹², the adaptation algorithm is biased in the negative direction. For ease of implementation, replacing (ρ) and (1−ρ) with integers T_{low} and T_{high} such that (ρ)/(1−ρ)=T_{low}/T_{high}, embodiments might employ a table of values for T_{low} and T_{high} for different BERs. At initialization, the roaming latch offset is set to be same as the error latch offset, and h_{0,k}^{r}=h_{0,k}^{e}. As the algorithm proceeds, every time the condition eₖ^{r}vₖ=−1 is met, the roaming latch is shifted down until a convergence condition is met. Upon convergence, the value of h_{0,k}^{r} gives the inner eye height at the target BER ρ.

In further embodiments, termination trimming with biased-BBPD and V-margin optimization might set the termination resistance to a pre-defined set of values and for each setting the updated V-margin is recorded. At the end of the termination sweep, the termination that offered the best V-margin is programmed into the front-end SerDes termination circuitry, matching the receiver input characteristics impedance with the actual channel characteristics impedance of the channel.

As would be apparent to one skilled in the art, the termination adaptation process might be extended with joint V- and H-margin optimization by maximizing the V and H product. Furthermore the proposed RX termination optimization can be extended to TX termination optimization if standards define an appropriate field for termination tuning support in the BCA training ordered set.

Reference herein to “one embodiment” or “an embodiment” means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

While the exemplary embodiments of the present invention have been described with respect to processes of circuits, including possible implementation as a single integrated circuit, a multi-chip module, a single card, or a multi-card circuit pack, the present invention is not so limited. As would be apparent to one skilled in the art, various functions of circuit elements may also be implemented as processing blocks in a software program. Such software may be employed in, for example, a digital signal processor, micro-controller, or general purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Further, the term “comprises or includes” and/or “comprising or including” used in the document means that one or more other components, steps, operation and/or existence or addition of elements are not excluded in addition to the described components, steps, operation and/or elements.

Signals and corresponding nodes or ports may be referred to by the same name and are interchangeable for purposes here.

No claim element herein is to be construed under the provisions of 35 U.S.C. §112, sixth paragraph, unless the element is expressly recited using the phrase “means for” or “step for.”

It is understood that various changes in the details, materials, and arrangements of the parts which have been described and illustrated in order to explain the nature of this invention may be made by those skilled in the art without departing from the scope of the embodiments of the invention as encompassed in the following claims.

1. A method of tuning an impedance in a receiver device, the method comprising:
initializing one or more initial termination settings of front-end circuitry impedance to an initial termination set for a predefined input of impedance value;
performing a recursive sweep over one or more termination settings to generate a set of recorded margins, the performing a recursive sweep including at each iteration:
generating a data eye from an input signal to a decision device, the input signal including a sequence of data symbols, the data eye including edges including a first inner edge and a second inner edge;
performing phase detection, by at least one biased phase detector, of at least two edges of the data eye, wherein the at least one biased phase detector is at least one bang-bang phase detector (BBPD);
generating a margin corresponding to at least one particular setting of one or more current termination settings of a settled phase based on a predefined criteria;
recording the margin corresponding to the at least one particular setting of the one or more current termination settings of the settled phase; and
updating the one or more current termination settings;
determining, when the recursive sweep is complete, a channel impedance-matched set of the one or more termination settings from the set of recorded margins; and
adjusting the one or more initial termination settings of front-end circuitry impedance to the channel impedance-matched set.

2. The method of claim 1, wherein the at least one BBPD is at least two BBPDs including a first BBPD and a second BBPD, wherein, the performing phase detection of at least two edges of the data eye comprises:
applying, at a current instant, present and past samples of the input signal to the first BBPD, the first BBPD being associated with detection of a first corner of the first inner edge of the data eye;
generating, by the first BBPD, an UP or a DOWN first value based on the present and past samples of the current instant;
weighting the UP or the DOWN first value with a corresponding first threshold value, each first threshold value selected to move the phase detection toward the first corner of the first inner edge of the data eye;
accumulating the weighted UP and DOWN first values over a period for phase detection;
detecting a phase of the first corner when the accumulated weighted UP and DOWN first values reach a converged stated;
applying, at the current instant, present and past samples of the input signal to the second BBPD, the second BBPD being associated with detection of a second corner of the second inner edge of the data eye;
generating, by the second BBPD, an UP or a DOWN second value based on the present and past samples of the current instant;
weighting the UP or the DOWN second value with a corresponding second threshold value, each second threshold value selected to move the phase detection toward the second corner of the second inner edge of the data eye;
accumulating the weighted UP and DOWN second values over the period for phase detection; and
detecting a phase of the second corner when the accumulated weighted UP and DOWN second values reach a converged stated.

3. The method of claim 1, wherein the generating a margin corresponding to at least one particular setting of one or more current termination settings of a settled phase includes generating a horizontal margin from first and second corners of the inner edges of the data eye.

4. The method of claim 3, wherein the generating the horizontal margin from first and second corners of the inner edges of the data eye is performed over a set of bit error rate (BER) values.

5. The method of claim 3, further comprising generating a vertical margin from a center of the data eye based on samples from an error latch and a roaming latch aligned in phase with the center of the data eye.

6. The method of claim 1, comprising transmitting information about one or more of the set of recorded margins and the one or more adjusted termination settings through a back-channel to a transmitter, the transmitter providing the input signal to the receiver.

7. The method of claim 1, comprising monitoring the receiver device over changing Process, Voltage and Temperature (PVT) conditions, wherein the method is applied repeatedly to maintain a relatively steady input impedance.

8. The method of claim 1, wherein the method is embodied in a Serializer/Deserializer (SerDes) device.

9. Apparatus for tuning an impedance in a receiver device, the apparatus comprising:
front-end circuitry having one or more initial termination settings of front-end circuitry impedance set to an initial termination set for a predefined input impedance value;
an impedance adaptation controller performing a recursive sweep over one or more termination settings to generate a set of recorded margins, including at each iteration:
generating a data eye from an input signal to a decision device, the input signal including a sequence of data symbols, the data eye including inner edges including a first inner edge and a second inner edge;
performing phase detection, by at least one biased phase detector, of the inner edges of the data eye, wherein the at least one biased phase detector is at least one bang-bang phase detector (BBPD);
generating a margin corresponding to at least one particular setting of one or more current termination settings of a settled phase based on a predefined criteria;
recording the margin corresponding to the at least one particular setting of the one or more current termination settings of the settled phase; and
updating the one or more current termination settings;
wherein the impedance adaptation controller is configured to determine a channel impedance-matched set of the one or more termination settings from the set of the recorded margins and adjust the one or more initial termination settings of front-end circuitry impedance to the channel impedance-matched set.

10. The apparatus of claim 9, wherein the at least one biased phase detector is at least two bang-bang phase detectors (BBPDs) including a first BBPD and a second BBPD, wherein, the impedance adaptation controller is configured to perform phase detection of the inner edges of the data eye by:
applying, at a current instant, present and past samples of the input signal to the first BBPD, the first BBPD being associated with detection of a first corner of the first inner edge of the data eye;
generating, by the first BBPD, an UP or a DOWN first value based on the present and past samples of the current instant;
weighting the UP or the DOWN first value with a corresponding first threshold value, each first threshold value selected to move the phase detection toward the first corner of the first inner edge of the data eye;
accumulating the weighted UP and DOWN first values over a period for phase detection;
detecting a phase of the first corner when the accumulated weighted UP and DOWN first values reach a converged stated;
applying, at the current instant, present and past samples of the input signal to the second BBPD, the second BBPD being associated with detection of a second corner of the second inner edge of the data eye;
generating, by the second BBPD, an UP or a DOWN second value based on the present and past samples of the current instant;
weighting the UP or the DOWN second value with a corresponding second threshold value, each second threshold value selected to move the phase detection toward the second corner of the second inner edge of the data eye;
accumulating the weighted UP and DOWN second values over the period for phase detection; and
detecting a phase of the second corner when the accumulated weighted UP and DOWN second values reach a converged stated.

11. The apparatus of claim 9, wherein the impedance adaptation controller is configured to generate a margin corresponding to the one or more current termination settings of a settled phase including generating a horizontal margin from first and second corners of the inner edges of the data eye.

12. The apparatus of claim 11, wherein the generating the horizontal margin from first and second corners of the inner edges of the data eye is performed over a set of bit error rate (BER) values.

13. The apparatus of claim 11, wherein the impedance adaptation controller is configured to generate a vertical margin from a center of the data eye based on samples from an error latch and a roaming latch aligned in phase with the center of the data eye.

14. The apparatus of claim 9, further comprising a receiver back-channel transmitter configured to transmit information about one or more of the set of recorded margins and the one or more adjusted termination settings through a back-channel to an external transmitter, the external transmitter providing the input signal to the receiver.

15. The apparatus of claim 9, wherein the apparatus is embodied in a Serializer/Deserializer (SerDes) device.

16. The apparatus of claim 9, wherein the apparatus is embodied in an integrated circuit.

17. A non-transitory machine-readable storage medium, having encoded thereon program code, wherein, when the program code is executed by a machine, the machine implements a method for tuning an impedance in a receiver device, comprising the steps of:
initializing one or more initial termination settings of front-end circuitry impedance to an initial termination set for a predefined input impedance value;
performing a recursive sweep over one or more termination settings to generate a set of recorded margins, the performing a recursive sweep including at each iteration:
generating a data eye from an input signal to a decision device, the input signal including a sequence of data symbols, the data eye including inner edges including a first inner edge and a second inner edge;
performing phase detection, by at least one biased phase detector, of the inner edges of the data eye to detect a phase of a first corner of the first inner edge of the data eye and a phase of a second corner of the second inner edge of the data eye;
generating a margin corresponding to at least one particular setting of one or more current termination settings of a settled phase; and
recording the margin corresponding to the at least one particular setting of the one or more current termination settings of the settled phase;
determining, when the recursive sweep is complete, a channel impedance-matched set of one or more termination settings from the set of the recorded margins; and
adjusting the one or more initial termination settings of front-end circuitry impedance to the channel impedance-matched set.

18. The non-transitory machine-readable storage medium of claim 17, wherein the at least one biased phase detector is at least two bang-bang phase detectors (BBPDs) including a first BBPD and a second BBPD, wherein, the performing phase detection of the inner edges of the data eye comprises:
applying, at a current instant, present and past samples of the input signal to the first BBPD, the first BBPD being associated with detection of a first corner of the first inner edge of the data eye;
generating, by the first BBPD, an UP or a DOWN first value based on the present and past samples of the current instant;
weighting the UP or the DOWN first value with a corresponding first threshold value, each first threshold value selected to move the phase detection toward the first corner of the first inner edge of the data eye;
accumulating the weighted UP and DOWN first values over a period for phase detection;
detecting the phase of the first corner when the accumulated weighted UP and DOWN first values reach a converged stated;
applying, at the current instant, present and past samples of the input signal to the second BBPD, the second BBPD being associated with detection of a second corner of the second inner edge of the data eye;
generating, by the second BBPD, an UP or a DOWN second value based on the present and past samples of the current instant;
weighting the UP or the DOWN second value with a corresponding second threshold value, each second threshold value selected to move the phase detection toward the second corner of the second inner edge of the data eye;
accumulating the weighted UP and DOWN second values over the period for phase detection; and
detecting the phase of the second corner when the accumulated weighted UP and DOWN second values reach a converged stated.

19. The non-transitory machine-readable storage medium of claim 17, wherein the generating a margin corresponding to the one or more current termination settings of a settled phase includes generating a horizontal margin from first and second corners of the inner edges of the data eye.

20. The non-transitory machine-readable storage medium of claim 19, wherein the generating the horizontal margin from first and second corners of the inner edges of the data eye is performed over a set of bit error rate (BER) values.
